(19) United States
(12) Patent Application Publication
(10) Pub. No.: US 2024/0405678 A1
(43) Pub. Date: Dec. 5, 2024

(54) VOLTAGE REGULATOR WITH HIGH RESPONSE TO LOAD FLUCTUATION AND REDUCING RIPPLE OF OUTPUT CURRENT WITHOUT NOISE FILTER, AND POWER CONVERTER APPARATUS WITH THE VOLTAGE REGULATOR

(71) Applicant: Panasonic Intellectual Property Management Co., Ltd., Osaka (JP)

(72) Inventors: Taiki NISHIMOTO, Osaka (JP); Masahiro YAMAOKA, Osaka (JP); Noriaki TAKEDA, Osaka (JP)

(21) Appl. No.: 18/697,682

(22) PCT Filed: Aug. 31, 2022
(86) PCT No.: PCT/JP2022/032825

§ 371 Date: Apr. 1, 2024

(30) Foreign Application Priority Data
Oct. 7, 2021 (JP) 2021-165502

(51) Int. Cl. H02M 3/158; H02M 1/14

(52) U.S. Cl. CPC H02M 3/158; H02M 1/14

(57) ABSTRACT

A voltage regulator includes chopper circuits connected in parallel, and a second series circuit. Each of the chopper circuits switches an input voltage and outputs the input voltage via a first inductor of a primary winding of a transformer, which includes the primary and secondary windings magnetically coupled with each other. The second series circuit includes a first series circuit and a third inductor connected in series, the first series circuit is configured by connecting second inductors of the secondary windings of the respective transformers of the chopper circuits in series, and both ends of the second series circuit are connected to first and second connection points connected to each other. The voltage regulator includes a first capacitor inserted between the first connection point and the output terminal, and a fourth inductor inserted between the first connection point and one end of one of the second inductors connected closest thereto.

### CROSS-REFERENCE OF RELATED APPLICATIONS

This application is the U.S. National Phase under 35 U.S.C. § 371 of International Patent Application No. PCT/JP2022/032825, filed on Aug. 31, 2022, which in turn claims the benefit of Japanese Patent Application No. 2021-165502, filed on Oct. 7, 2021, the entire disclosures of which applications are incorporated by reference herein.

### TECHNICAL FIELD

The present disclosure relates to a voltage regulator and a power converter apparatus including the voltage regulator.

### BACKGROUND ART

Power consumption of a central processing unit (CPU) or a graphics processing unit (GPU) for a server apparatus rapidly changes according to an operating state thereof. Therefore, a CPU power supply apparatus or a GPU power supply apparatus is required to have basic performance of outputting a constant voltage with high accuracy in response to a load fluctuation instantaneously. Up to now, an interleaved step-down DC-DC conversion circuit or the like has been used, but in recent years, a trans-inductor voltage regulator (TLVR) has been proposed.

Non-Patent Documents 1 and 2 disclose a circuit configuration of the TLVR. In the TLVR, a reactor of each phase in an interleaved step-down DC-DC conversion circuit is replaced with a transformer, and a secondary winding of the transformer and a compensation inductor are connected in series to form a loop circuit. When the load fluctuates, an induced current is generated in the loop circuit, so that the output current of the TLVR can be instantaneously changed.

### PRIOR ART DOCUMENTS

### Non-Patent Documents

Non-patent Document 1: author: none, “Fast multi-phase trans-inductor voltage regulator,” Defensive Publications Series, Art. 2190 [2019], Published by Technical Disclosure Commons on May 9, 2019, [searched on Sep. 26, 2021], Internet, <URL: https://www.tdcommons.org/cgi/viewcontent.cgi?article=3261&context=dpubs_series>
Non-patent Document 2: Nian Zhang et al., “Analysis of Multi-Phase Trans-Inductor Voltage Regulator with Fast Transient Response for Large Load Current Applications,” 2021 IEEE International Symposium on Circuits and Systems (ISCAS), IEEE Conference Proceedings, pp. 1-5, published on Apr. 27, 2021

### SUMMARY OF THE INVENTION

### Problems to be Solved by the Invention

However, the output current of the TLVR includes a ripple component of the phase order of the switching frequency. Therefore, in order to suppress noise propagated to the CPU or the GPU, a large noise filter is required. This may prevent downsizing of a power supply circuit.

The TLVR is expected to be used as a point of load (POL) power supply apparatus in which a power supply circuit is arranged close to a CPU or a GPU. When the size of the noise filter for filtering the output current increases, the wiring length to the load increases, and thus there is a concern about an increase in voltage drop or power loss due to a resistance component of the wiring. Therefore, the POL power supply apparatus is required to suppress ripples of the output current without using a large noise filter.

An object of the present disclosure is to provide a voltage regulator capable of suppressing ripples of an output current while maintaining a high response to a load fluctuation without using a large noise filter in a voltage regulator such as TLVR, and a power converter apparatus including the voltage regulator.

### Means for Dissolving the Problems

According to one aspect of the present disclosure, a voltage regulator is provided to include a plurality of chopper circuits, and a second series circuit. The plurality of chopper circuits is connected in parallel between an input terminal and an output terminal, and each of the plurality of chopper circuits is configured to switch an input voltage input to the input terminal, and then output the input voltage from the output terminal via a first inductor of a primary winding of a transformer. The transformer includes the primary winding and a secondary winding that are magnetically coupled with each other. The second series circuit includes a first series circuit and a third inductor that are connected in series, the first series circuit is configured by connecting respective second inductors of the secondary windings of the respective transformers of the plurality of chopper circuits in series, and both ends of the second series circuit are connected to first and second connection points connected to each other. The voltage regulator includes a first capacitor and a fourth inductor. The first capacitor is connected to be inserted between the first connection point and the output terminal. The fourth inductor is configured to be one of the following:
(1) the fourth inductor is connected to be inserted between the first connection point and one end of one of the second inductors that is connected closest to the first connection point,
(2) the fourth inductor is connected to be inserted between the second connection point and one end of one of the second inductors that is connected closest to the second connection point, or
(3) the fourth inductor is connected to be inserted between any pair of adjacent inductors of the plurality of second inductors.

### Effects of the Invention

Therefore, according to the voltage regulator according to one aspect of the present disclosure, it is possible to significantly suppress ripples of the output current. As a result, it is possible to reduce the noise filter, reduce the size and weight of the apparatus, and reduce the cost as compared with the power converter apparatus according to the conventional example.

### BRIEF DESCRIPTION OF THE DRAWINGS

FIG. 1 is a circuit diagram illustrating a configuration example of a DC-DC converter apparatus 1 including a voltage regulator according to a first embodiment.

FIG. 2 is a circuit diagram illustrating a configuration of a DC-DC converter apparatus 1A including an interleaved step-down chopper circuit according to a first conventional example.

FIG. 3 is a timing chart of each gate control signal and each current, illustrating the operation of the DC-DC converter apparatus 1A of FIG. 2.

FIG. 4 is a circuit diagram illustrating a configuration of a DC-DC converter apparatus 1B including a TLVR according to a second conventional example.

FIG. 5 is a timing chart of each gate control signal and each current, illustrating the operation of the DC-DC converter apparatus 1B of FIG. 4.

FIG. 6 is a timing chart of each gate control signal and each current, illustrating the operation of the DC-DC converter apparatus 1 of FIG. 1.

FIG. 7 is a waveform diagram of a total current I1 illustrating a simulation result of the DC-DC converter apparatus 1B of FIG. 4.

FIG. 8 is a waveform diagram of an output current I2 illustrating a simulation result of the DC-DC converter apparatus 1 of FIG. 1.

FIG. 9 is a circuit diagram illustrating a configuration example of a DC-DC converter apparatus 1C including a voltage regulator according to a first modified embodiment.

FIG. 10 is a circuit diagram illustrating a configuration example of a DC-DC converter apparatus 1D including a voltage regulator according to a second modified embodiment.

FIG. 11 is a circuit diagram illustrating a configuration example of a DC-DC converter apparatus 1F including a voltage regulator according to a third modified embodiment.

FIG. 12 is a circuit diagram illustrating a configuration example of a DC-DC converter apparatus 1E including a voltage regulator according to a second embodiment.

FIG. 13 is a diagram illustrating a setting example table of a capacitor C3 of the DC-DC converter apparatus 1E of FIG. 12.

FIG. 14 is a waveform diagram of an output current I2 illustrating a simulation result of the DC-DC converter apparatus 1E in FIG. 12.

FIG. 15 is a block diagram showing a configuration example of a power converter apparatus 100 according to a third embodiment.

### DETAILED DESCRIPTION

Hereinafter, embodiments and modified embodiments according to the present disclosure will be described with reference to the drawings. It is noted that the same or similar components are denoted by the same reference numerals.

### First Embodiment

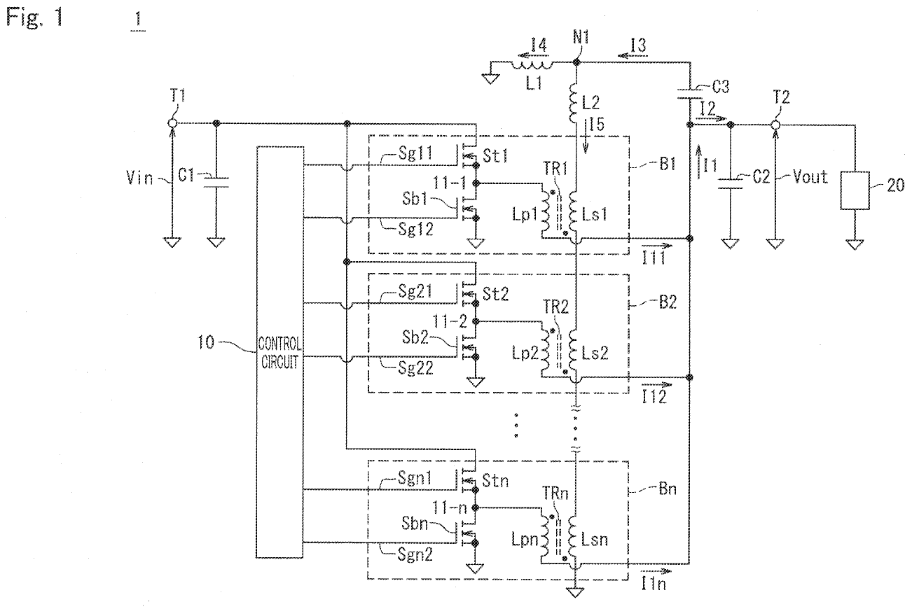

FIG. 1 is a circuit diagram illustrating a configuration example of a DC-DC converter apparatus 1 including a voltage regulator according to a first embodiment. In this case, the DC-DC converter apparatus 1 is an example of a power converter apparatus.

Referring to FIG. 1, the DC-DC converter apparatus 1 is configured such that a smoothing capacitor C1, a plurality of n step-down chopper circuits B1 to Bn connected in parallel to each other, and a smoothing capacitor C2 are connected in series between an input terminal T1 and an output terminal T2. In this case, the smoothing capacitor C1 smooths the input voltage Vin, which is a DC voltage applied to the input terminal T1, and outputs the smoothed input voltage Vin to each of the step-down chopper circuits B1 to Bn. The step-down chopper operation (or step-down switching operation) of each of the step-down chopper circuits B1 to Bn is controlled based on gate control signals Sg11, Sg12; Sg21, Sg22; . . . ; Sgn1, Sgn2 from the control circuit 10. That is, the step-down chopper circuits B1 to Bn include switching circuits 11-1 to 11-n, respectively, and the switching circuits 11-1 to 11-n switch the input voltage Vin according to gate control signals Sg11, Sg12; Sg21, Sg22; . . . ; Sgn1, Sgn2 to convert the input voltage Vin into an AC voltage and output the AC voltage to inductors Lp1 to Lpn of primary windings of transformers TR1 to TRn. Output currents I11, I12, . . . , I1n from the respective step-down chopper circuits B1 to Bn are merged at the output terminal T2, and a part of a current I3 of a total current I1 flows through the capacitor C3. A remaining current I2 (=I1−I3) is output to a load 20 via a smoothing capacitor C2. In this case, the voltage of the output terminal T2 is an output voltage Vout.

Next, a detailed configuration of each of the step-down chopper circuits B1 to Bn will be described below.

The step-down chopper circuit B1 includes a pair of switch elements St1 and Sb1 connected in series to each other to configure the switching circuit 11-1, and a transformer TR1. In this case, the switch element St1 is a high-side switch element, and the switch element Sb1 is a low-side switch element. The connection point between the source of the switch element St1 and the drain of the switch element Sb1 is one end of the inductor Lp1 of the primary winding of the transformer TR1 (winding start point; indicated by a black circle). The transformer TR1 includes the inductor Lp1 of the primary winding and an inductor Ls1 of a secondary winding, which are magnetically coupled in directions opposite to each other. The other end (winding end point) of the inductor Lp1 of the primary winding is connected to the output terminal T2.

The step-down chopper circuit B2 includes a pair of switch elements St2 and Sb2 connected in series to each other to configure the switching circuit 11-2, and a transformer TR2, in a manner similar to that of the step-down chopper circuit B1. The transformer TR2 includes the inductor Lp2 of the primary winding and an inductor Ls2 of a secondary winding, which are magnetically coupled in directions opposite to each other. The other end (winding end point) of the inductor Lp2 of the primary winding is connected to the output terminal T2.

The step-down chopper circuits B3 to Bn are configured in a manner similar to that of the step-down chopper circuits B1 and B2. The step-down chopper circuit Bn includes a pair of switch elements Stn and Sbn connected in series to each other to configure the switching circuit 11-n, and a transformer TRn, in a manner similar to that of the step-down chopper circuits B1 and B2. The transformer TRn includes the inductor Lpn of the primary winding and an inductor Lsn of a secondary winding, which are magnetically coupled in directions opposite to each other. The other end (winding end point) of the inductor Lpn of the primary winding is connected to the output terminal T2.

The output terminal T2 is grounded via the capacitor C3, the node N1, and the inductor L1, and the node N1 is grounded via the inductor L2, one end (winding end point) and the other end (winding start point) of the inductor Ls1, one end (winding end point) and the other end (winding start point) of the inductor Ls2, . . . , one end (winding end point) and the other end (winding start point) of the inductor Lsn. That is, the node N1 is a first connection point that connects together one end of the inductor L1, one end of the inductor L2, and one end of the capacitor C3. In addition, the first connection point is connected to one end of the inductor Ls1 via the inductor L2 and a second connection point. In this case, the current flowing through the capacitor C3 is I3, the current flowing through the inductor L2 is I5, and the current flowing through the inductor L1 is I4.

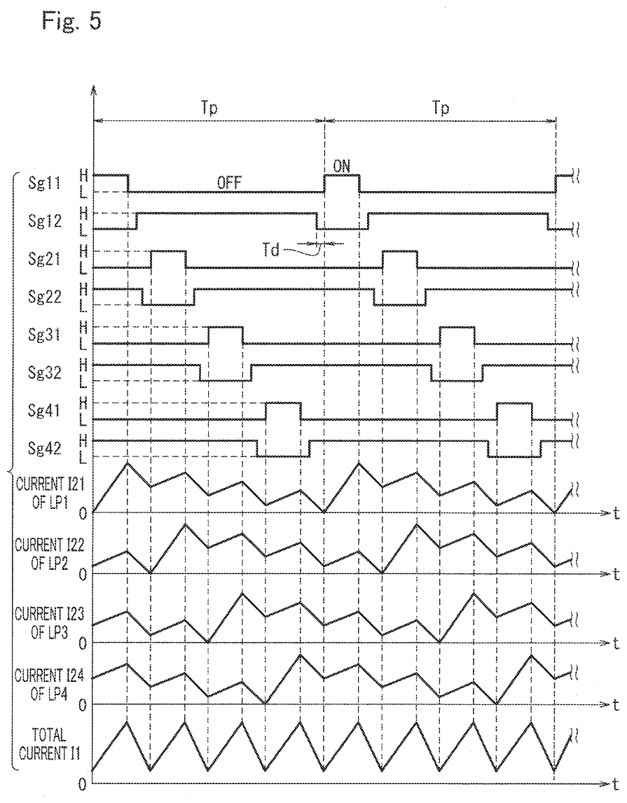

Referring to FIG. 1, in a current continuous mode, when the duty ratio of the gate control signal Sg11 of the switch element St1 is denoted by D, the duty ratio of the gate control signal Sg12 of the switch element Sb1 is (1-D), and the switch elements St1 and Sb1 are alternately on/off controlled. However, strictly speaking, a constant dead time Td (see FIG. 5 and the like) is provided from when one switch element is turned off until the other switch element is turned on so that the switch elements St1 and Sb1 are not simultaneously turned on.

The DC-DC converter apparatus 1 including the voltage regulator configured as described above is a plurality-n-phase interleaved circuit in which a plurality of n step-down chopper circuits B1 to Bn are connected in parallel to the input terminal T1. The gate control signals Sg11 to Sgn2 are given from the control circuit 10 so that the step-down chopper circuits B1 to Bn of the respective phases operate in the operation phases shifted by 2πt/n. The voltage Vout is output to the output terminal T2, and the relationship with the input voltage Vin is expressed by the following equation:

Vout=D×Vin.

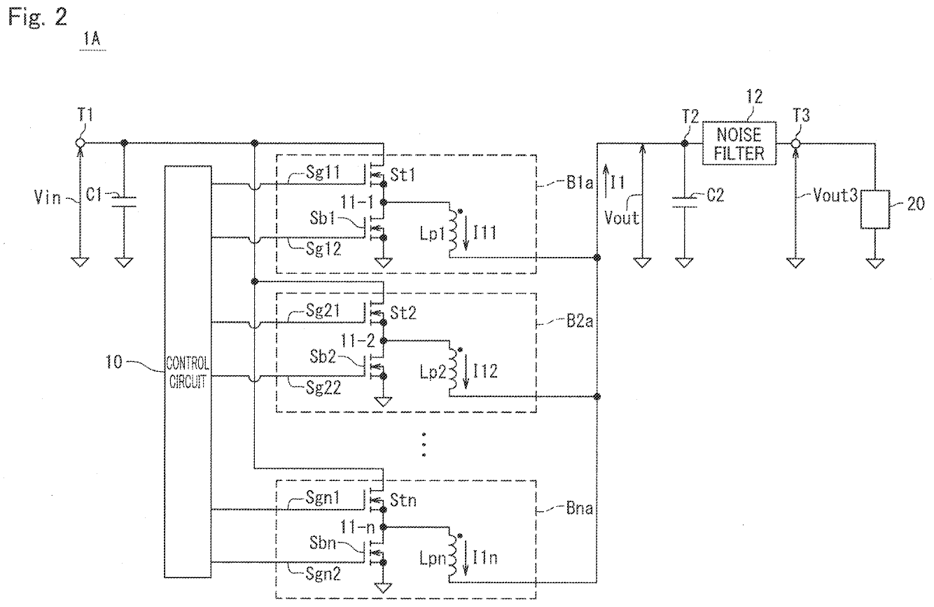

FIG. 2 is a circuit diagram illustrating a configuration of a DC-DC converter apparatus 1A including an interleaved step-down chopper circuit according to a first conventional example.

Referring to FIG. 2, the DC-DC converter apparatus 1A is different from the DC-DC converter apparatus 1 of FIG. 1 in the following points.
(1) The inductor Ls1 of the secondary winding of TR1 is removed, and the switching circuit 11-1 including the pair of switch elements St1 and Sb1 and the inductor Lp1 configures a step-down chopper circuit B1a.
(2) The inductor Ls2 of the secondary winding of TR2 is removed, and the switching circuit 11-2 including the pair of switch elements St2 and Sb2 and the inductor Lp2 configures a step-down chopper circuit B2a.
(3) In a manner to similar to above, the inductor Lsn of the secondary winding of TRn is removed, and the switching circuit 11-n including the pair of switch elements Stn and Sbn and the inductor Lp2n configures a step-down chopper circuit Bna.
(4) The inductors L1 and L2 and the capacitor C3 are removed.
(5) The output voltage Vout of the output terminal T2 is output to the load 20 as an output voltage Vout3 via a noise filter 12 and an output terminal T3.

In the DC-DC converter apparatus 1A according to the first conventional example configured as described above, for example, focusing on the step-down chopper circuit B1a, the current of the inductor Lp1 increases when the high-side switch element St1 is turned on, and decreases when the high-side switch element St1 is turned off.

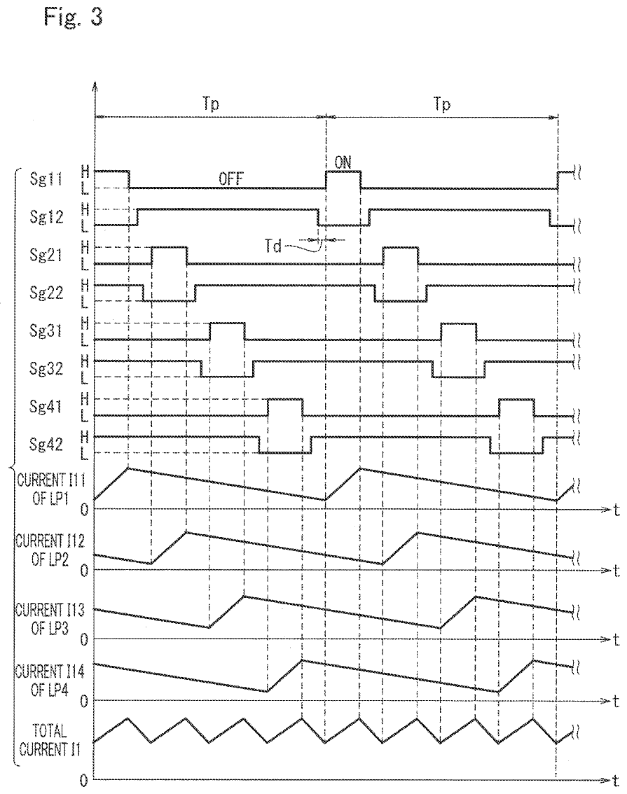

FIG. 3 is a timing chart of each gate control signal and each current, illustrating the operation of the DC-DC converter apparatus 1A of FIG. 2. The DC-DC converter apparatus 1A of FIG. 2 repeats the same operation in a period Tp. In this case, for example, in a case where the number of phases is four, FIG. 3 illustrates currents of the inductors Lp1 to Lp4 of the respective phases and the total current I1 thereof. The total current I1 includes a ripple component that is a multiple of the switching frequency (4 times in FIG. 3). Among them, since the ripple component that cannot be completely absorbed by the capacitor C2 propagates to the load 20 (CPU or GPU), it is necessary to separately provide the noise filter 12 between the output terminal T2 and the load to suppress the ripple component.

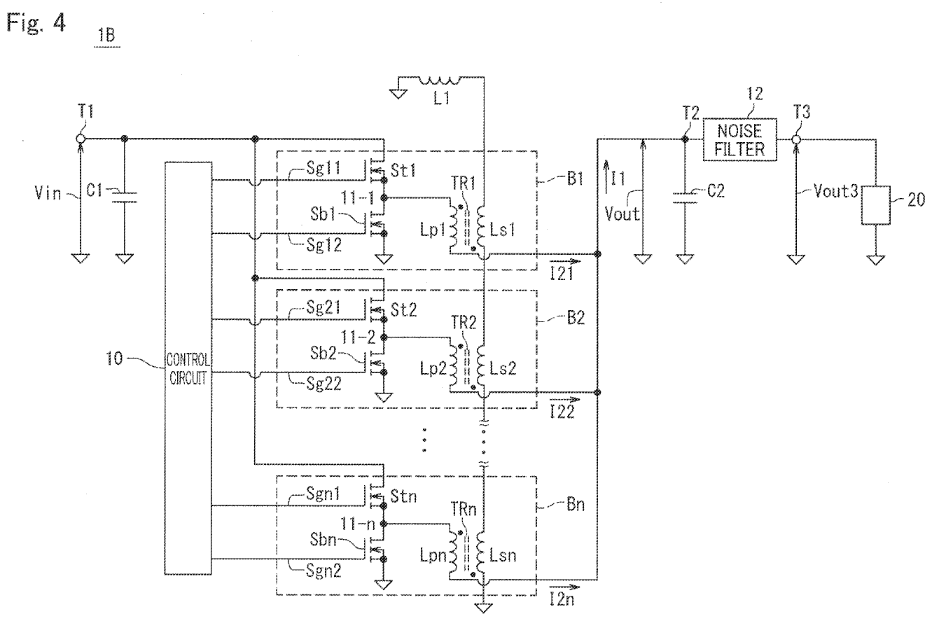

FIG. 4 is a circuit diagram illustrating a configuration of a DC-DC converter apparatus 1B including a TLVR according to a second conventional example.

Referring to FIG. 4, the DC-DC converter apparatus 1B is different from the DC-DC converter apparatus 1 of FIG. 1 in the following points.
(1) The inductor L2 and the capacitor C3 are removed.
(2) The output voltage Vout of the output terminal T2 is output to the load 20 as the output voltage Vout3 via the noise filter 12 and the output terminal T3.

In the DC-DC converter apparatus 1B configured as described above, as compared with the DC-DC converter apparatus 1A including the interleaved step-down chopper circuit in FIG. 2, the currents I11 to I1n of the inductors Lp1 to Lpn are also affected by other phases through the loop circuits of the inductors L1 and Ls1 to Lsn.

FIG. 5 is a timing chart of each gate control signal and each current, illustrating the operation of the DC-DC converter apparatus 1B of FIG. 4. In this case, for example, in a case where the number of phases is four, FIG. 5 illustrates the currents of the inductors Lp1 to Lp4 of the respective phases and the total current I1 thereof. Since the total current I1 includes a ripple component of a multiple of the switching frequency (4 times in FIG. 5) in a manner similar to that of the DC-DC converter apparatus 1A of FIG. 3, the noise filter 12 (FIG. 4) is required.

Although depending on the set circuit constant, in the DC-DC converter apparatus 1B including the TLVR according to the second conventional example, the ripple component included in the output current tends to be larger than that in the interleaved step-down chopper circuit according to the first conventional example. This is because, as can be seen by comparing FIG. 3 and FIG. 5, the current itself of each of the inductors Lp1 to Lp4 of the respective phases of the TLVR according to the second conventional example includes a ripple component that is a multiple of the switching frequency. Therefore, in order to utilize the TLVR according to the second conventional example as a POL power supply apparatus, a technique for suppressing a ripple component of the total current I1 is important.

Finally, the operation of the DC-DC converter apparatus 1 according to the first embodiment will be described with reference to the current path diagram illustrated in FIG. 1. As compared with the DC-DC converter apparatus 1B including the TLVR according to the second conventional example, a part of the current component I3 among the total sum I1 of the currents of the inductors Lp1 to Lpn flows to the capacitor C3 and, thus, the current I2 (=I1−I3) flows to the output terminal T2.

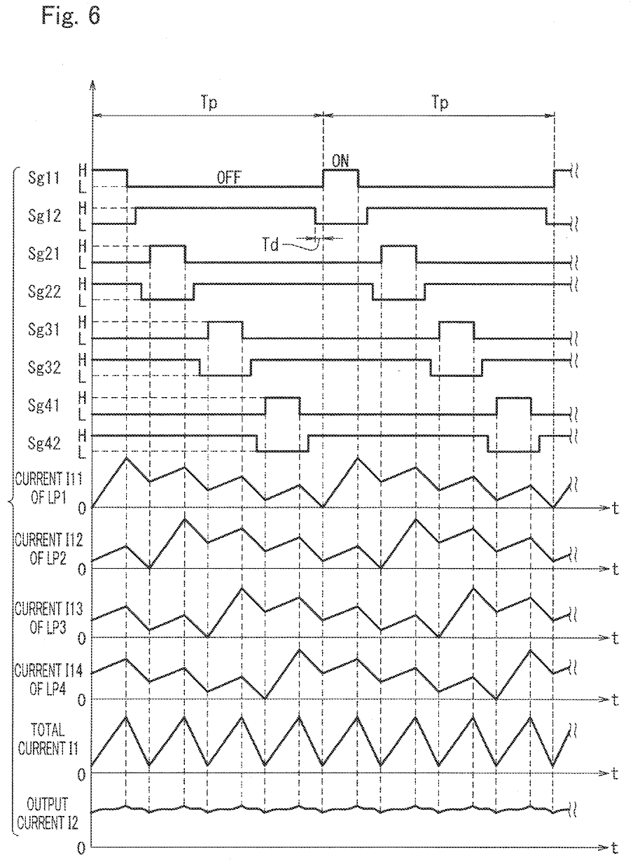

FIG. 6 is a timing chart of each gate control signal and each current, illustrating the operation of the DC-DC converter apparatus 1 of FIG. 1. As will be described in detail later, in a case where the capacitance value of the capacitor C3 is correctly set, the ripple component of the output current I2 can be suppressed as illustrated in FIG. 8. On the other hand, when the capacitance value of the capacitor C3 is not specified or not correctly set, the ripple component of the output current I2 can be amplified.

In addition, in the DC-DC converter apparatus 1 according to the first embodiment illustrated in FIG. 1, there is a loop circuit including only inductors including the inductors L1 and L2 and Ls1 to Lsn. In addition, in the DC-DC converter apparatus 1B including the TLVR according to the second conventional example illustrated in FIG. 4, there is a loop circuit including only inductors including the inductors L1 and Ls1 to Lsn. The loop circuit including only the inductors can achieve high-speed load response performance. For example, in a case where the output current increases with a sudden change in load, in the case of the DC-DC converter apparatus 1A including the interleaved step-down chopper circuit according to the first conventional example illustrated in FIG. 2, in order to increase the currents of the inductors Lp1 to Lpn of the respective phases, it takes time to store magnetic energy in the magnetic cores of the inductors Lp1 to Lpn, and thus, it is not possible to respond instantly.

On the other hand, in the DC-DC converter apparatus 1B including the TLVR according to the second conventional example or the DC-DC converter apparatus 1 according to the first embodiment, it is possible to increase the currents of the inductors Lp1 to Lpn of the respective phases without accumulating magnetic energy in the magnetic core by inducing a current in the above-described loop circuit. That is, the DC-DC converter apparatus 1 according to the first embodiment can suppress the noise current of the output terminal T2 while maintaining the same load response as that of the DC-DC converter apparatus 1B including the TLVR according to the second conventional example. It is noted that even in a circuit similar to that of the DC-DC converter apparatus 1, it is not possible to realize high-speed load response in a circuit in which a loop of only an inductor does not exist, for example, by inserting a capacitor in series with the inductors Ls1 to Lsn or the like.

Next, a setting condition of the capacitor C3 for suppressing noise of the output current I2 will be described with reference to FIG. 1.

In this case, the switching frequency of the switching circuits 11-1 to 11-n of the respective phases is fs (switching angular frequency ωs=2πfs), and the number of interleaved phases is plurality n. As described above, when the operation phases of the switching circuits 11-1 to 11-n of the respective phases are shifted by 2π/n for operation, the primary to n−1 order current components are canceled out by the effect of interleaving and do not appear in the output current I2. Therefore, it is important to suppress a plurality of nth-order current components. In the following equation expansion, components other than the nth-order frequency components are ignored. In addition, inductances of the inductors Lp1 to Lpn are Lp, and inductances of the inductors Ls1 to Lsn are Ls. It is assumed that the inductors Lp1 to Lpn and the inductors Ls1 to Lsn are tightly coupled, and the coupling coefficient can be approximated to 1.

A plurality of nth-order ripple components ip included in the currents flowing through the inductors Lp1 to Lpn of the respective phases is defined by the following equation (1):

$${i}_{p} = A sin ( n {ω}_{s} t ) , \qquad ( 1 )$$

where, A is a predetermined constant.

Referring to FIG. 1, in the total current I1, the nth-order ripple components included in the currents flowing through the inductors Lp1 to Lpn of the respective phases are in the same phase and intensify each other. Therefore, an nth-order ripple component included in an instantaneous current i₁ of the total current I1 is expressed by the following equation (2):

$${i}_{1} = nA sin ( n {ω}_{s} t ) . \qquad ( 2 )$$

When all the nth-order ripple components included in the total current I1 flow into the capacitor C3 (I1=I3), a voltage v3 between the terminals of the capacitor C3 is expressed by the following equation (3):

$${v}_{3} = - \frac{A}{{ω}_{s} {C}_{3}} cos ( n {ω}_{s} t ) . \qquad ( 3 )$$

At this time, since the voltage potential of the node N1 vibrates in the opposite phase to the inter-terminal voltage v3 of the capacitor C3, an instantaneous current i₄ of the current I4 flowing through the inductor L1 and an instantaneous current i₅ of the current I5 flowing through the inductor L2 are expressed by the following equations (4) and (5), respectively:

$${i}_{4} = \frac{A}{n {ω}_{s}^{2} {L}_{1} {C}_{3}} sin ( n {ω}_{s} t ) , \qquad ( 4 )$$

$$and$$

$${i}_{5} = A \frac{n \sqrt{{L}_{p} {L}_{S}} + \frac{1}{n {ω}_{s}^{2} {C}_{3}}}{{L}_{2} + {nL}_{s}} sin ( n {ω}_{s} t ) . \qquad ( 5 )$$

According to Kirchhoff's current law, the current I3=I4+I5, and the conditional formula of the capacitor C3 satisfying this is expressed by the following equation (6):

$${C}_{3} = \frac{{L}_{2} + {nL}_{s} + {L}_{1}}{{n}^{2} {ω}_{s}^{2} {L}_{1} ( {L}_{2} + {nL}_{s} - \sqrt{{L}_{p} {L}_{s}} )} . \qquad ( 6 )$$

When the capacitor C3 satisfies the above equation (6), since the current I1=I3, the output current I2=0 according to Kirchhoff's current law, and the output current I2 does not include any nth-order current component. That is, all the nth-order noise current components can be canceled out.

Although the above is the optimum condition, if the capacitance value of the capacitor C3 is set as in the following equation (7), a noise reduction effect of 6 dB or more can be obtained. That is, the amplitude of the noise current is suppressed to half or less.

$$\frac{{L}_{2} + {nL}_{s} + {L}_{1}}{{n}^{2} {ω}_{s}^{2} {L}_{1} \{ 1.5 ( {L}_{2} + {nL}_{s} ) - \sqrt{{L}_{p} {L}_{s}} \}} < {C}_{3} < \frac{{L}_{2} + {nL}_{s} + {L}_{1}}{{n}^{2} {ω}_{s}^{2} {L}_{1} \{ 0.5 ( {L}_{2} + {nL}_{s} ) - \sqrt{{L}_{p} {L}_{s}} \}} . \qquad ( 7 )$$

Also in this case, by reducing the number of components of the noise filter 12, downsizing and cost reduction can be realized.

As illustrated in FIG. 1, the inductors Lp1 to Lpn and the inductors Ls1 to Lsn are magnetically coupled in directions in which magnetic fluxes intensify each other when currents flow from the terminals of the winding start points denoted by black circles. As a result, the above-described noise suppression effect can be obtained.

Next, as an example, the present inventors performed circuit simulation on the DC-DC converter apparatus 1 including step-down chopper circuits B1 to B4 of the four-phase interleaving (n=4) system operating in four phases different from each other. Hereinafter, the effect of reducing the ripple current will be described with reference to the circuit simulation results.

First, simulation results of the DC-DC converter apparatus 1B including the TLVR according to the second conventional example illustrated in FIG. 4 will be described below.

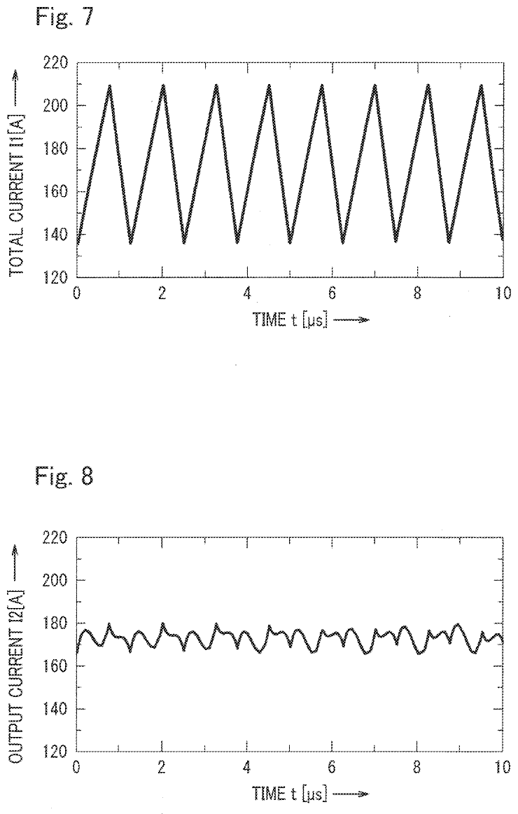

FIG. 7 is a waveform diagram of the total current I1 illustrating a simulation result of the DC-DC converter apparatus 1B of FIG. 4. In this case, the inductance Lp=Ls=1 μH, the inductor L1=0.2 μH, and the switching frequency fs=200 kHz. In addition, it is assumed that the input voltage Vin=12 V and the output voltage Vout=1.8 V.

As is clear from FIG. 7, as also illustrated in FIG. 5, the total current I1 includes a triangular-wave-shaped ripple component of 4 times the switching frequency, and its amplitude is 75 Ap-p, which is very large.

Next, a simulation result of the DC-DC converter apparatus 1 according to the first embodiment illustrated in FIG. 1 will be described. In this case, the inductance Lp=Ls=1 pH, the inductor L1=20 nH, the inductor L2=0.2 pH, and the switching frequency fs=200 kHz. At this time, the optimum capacitance value of the capacitor C3 is calculated to be 2.61 μF by the equation (6).

FIG. 8 is a waveform diagram of the output current I2 illustrating a simulation result of the DC-DC converter apparatus 1 of FIG. 1. In this case, it is assumed that the input voltage Vin=12 V and the output voltage Vout=1.8 V.

As is clear from FIG. 8 and also illustrated in FIG. 6, the ripple component of 4 times the switching frequency included in the total current I1 is removed, and the amplitude of the output current I2 is remarkably suppressed to 13 App.

The response speed to a sudden change in the load capacitance is determined by the total inductance of the loop circuit of the inductor. In the above simulation, the value of Ls is set to be the same between the second conventional example and the first embodiment. Therefore, when compared with other inductances, L1=0.2 μH in the second conventional example, and L1+L2=0.22 μH in the first embodiment, so that the response speeds are substantially the same.

In the above embodiment, the case of the four-phase interleaved DC-DC converter apparatus 1 has been described, but the number of phases is not limited, and the present disclosure may be applied to any plurality-n-phase interleaved DC-DC converter apparatus such as 16 phases. As a result, in an interleaved DC-DC converter apparatus having an arbitrary number of phases, noise of the output current I2 can be suppressed.

As described above, according to the present embodiment, for example, in a voltage regulator such as TLVR, it is possible to provide a voltage regulator capable of suppressing ripples of an output current while maintaining the response to a load fluctuation without using a large noise filter, and a power converter apparatus including the voltage regulator.

### First Modified Embodiment

In the above embodiment, among the inductors Lp1 to Lpn, a pair of, a plurality of pairs of, or a combination of three or more inductors may be magnetically coupled to each other. An example thereof will be described below.

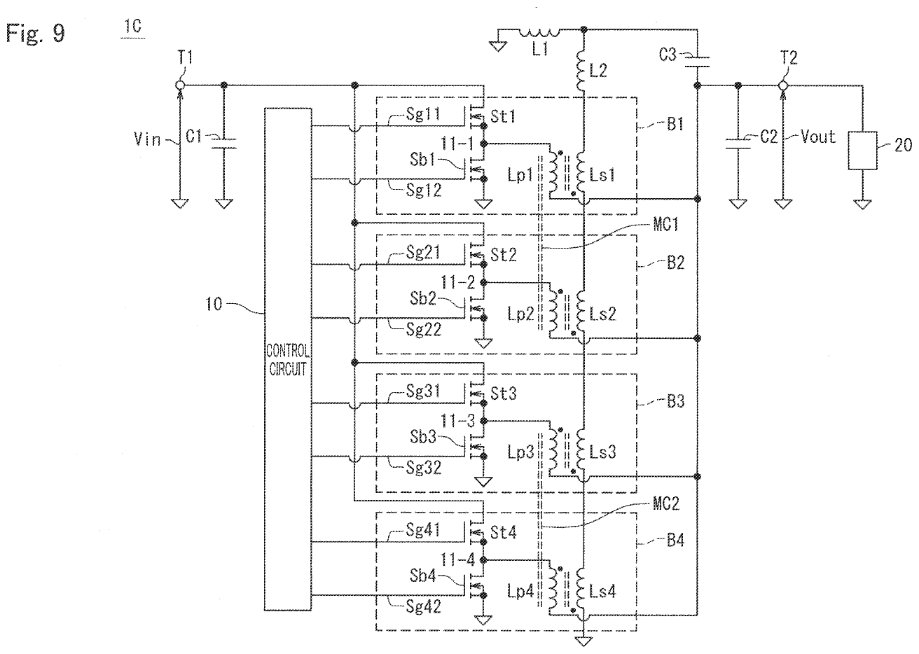

FIG. 9 is a circuit diagram illustrating a configuration example of a DC-DC converter apparatus 1C including a voltage regulator according to a first modified embodiment. The DC-DC converter apparatus 1C of FIG. 9 is an example of a power converter apparatus. For example, as illustrated in FIG. 9, in the case of a four-phase interleaved DC-DC converter apparatus, the inductor Lp1 and the inductor Lp2 may be magnetically coupled MC1, and the inductor Lp3 and the inductor Lp4 may be magnetically coupled MC2. It is noted that the magnetic coupling of the first modified embodiment may be applied to other modified embodiments and other embodiments.

In a manner similar to above, in the case of an 8-phase or 16 phase interleaved DC-DC converter apparatus, for example, four-phase inductors may be magnetically coupled to each other. As a result, the response speed to the load fluctuation can be further increased as compared with the case where the magnetic coupling is not performed.

As the switch elements St1 to Stn and Sb1 to Sbn, a transistor such as a MOS field effect transistor (MOSFET) or a GaN-HEMT (High Mobility Electron Transistor) may be used. Instead of this, a diode may be used for the switch elements Sb1 to Sbn.

In addition, in FIG. 1, since the inductor L2 and the inductors Ls1 to Lsn are connected in series, the order of connection may be switched. That is, the inductor L2 may be connected to be inserted between the node N1 and the inductor Ls1 as illustrated in FIG. 1, or may be connected as follows.
(1) The inductor L2 may be connected to be inserted between one end of the inductor Lsn connected to the ground and the ground.
(2) The inductor L2 may be connected to be inserted between any pair of adjacent inductors among the plurality of n inductors Ls1 to Lsn.

As a result, the component arrangement on the circuit board can be optimized, and the mounting area can be further suppressed.

### Second Modified Embodiment

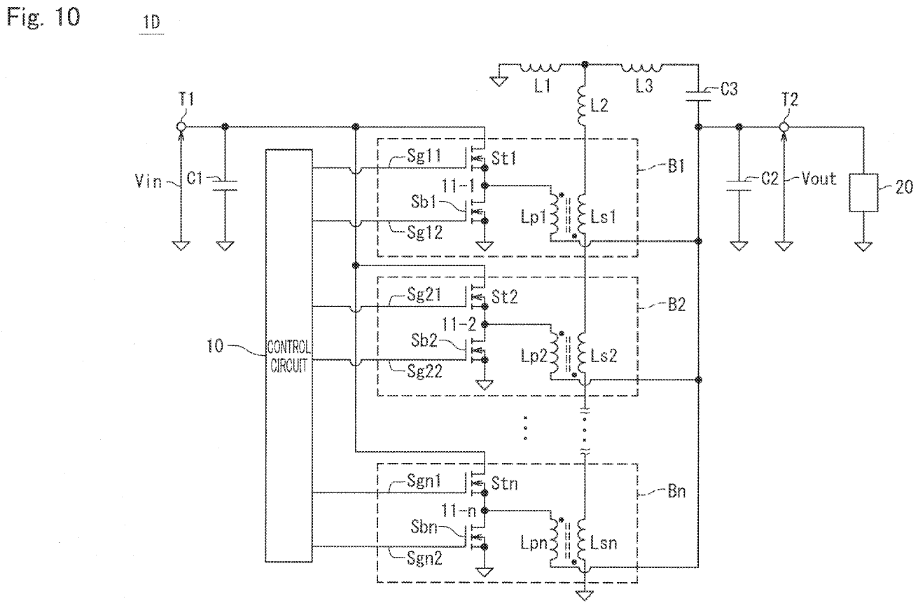

FIG. 10 is a circuit diagram illustrating a configuration example of a DC-DC converter apparatus 1D including a voltage regulator according to a second modified embodiment. Referring to FIG. 10, the DC-DC converter apparatus 1D according to the second modified embodiment is different from the DC-DC converter apparatus 1 according to the first embodiment in FIG. 1 in the following points.
(1) An inductor L3 is further provided between the node N1 and the capacitor C3.

The insertion of the inductor L3 of the second modified embodiment may be applied to other modified embodiments and other embodiments.

In the DC-DC converter apparatus 1D configured as described above, even when the inductance of the inductor L1 is relatively small, it is possible to prevent a large current such as an inrush current from flowing through the capacitor C3 to cause breakdown of other components. In this case, since the inductor L3 and the capacitor C3 are connected in series, the order of connection may be reversed.

### Third Modified Embodiment

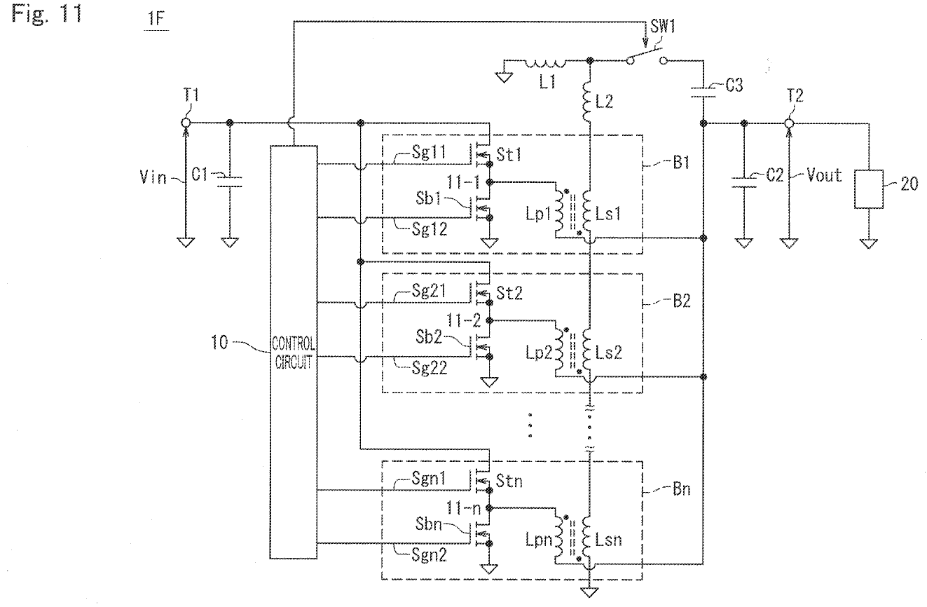

FIG. 11 is a circuit diagram illustrating a configuration example of a DC-DC converter apparatus 1F including a voltage regulator according to a third modified embodiment. Referring to FIG. 11, the DC-DC converter apparatus 1F according to the third modified embodiment is different from the DC-DC converter apparatus 1 according to the first embodiment in FIG. 1 in the following points.
(1) A switch SW1 is further provided between the node N1 and the capacitor C3.
(2) The switch SW1 switches over between on and off in accordance with a command from the control circuit 10.

It is to be noted that the insertion of the switch SW1 of the third modified embodiment may be applied to other modified embodiments and other embodiments.

The switch SW1 may include a transistor such as a MOSFET or a GaN-HEMT. Alternatively, the switch SW1 may be a mechanical switch such as a relay. In addition, when a transistor is used as the switch SW1, a terminal on a side close to the node N1 may be used as the source terminal.

In the DC-DC converter apparatus 1F configured as described above, both ripple suppression and high-speed response are achieved by turning on the switch SW1 at the normal time. On the other hand, when the switch SW1 is off, only the ripple suppression function can be disabled. For example, when an abnormal overcurrent flows through the capacitor C3, the switch SW1 is temporarily turned off and, thus, destruction of the capacitor C3 can be suppressed. In addition, by turning off the switch SW1 when the capacitor C3 is broken, the power conversion can be continued without impairing the transient response performance. That is, the power supply function can be maintained until the load is safely stopped (shut down). In this case, since the switch SW1 and the capacitor C3 are connected in series, the order of connection may be reversed.

### Second Embodiment

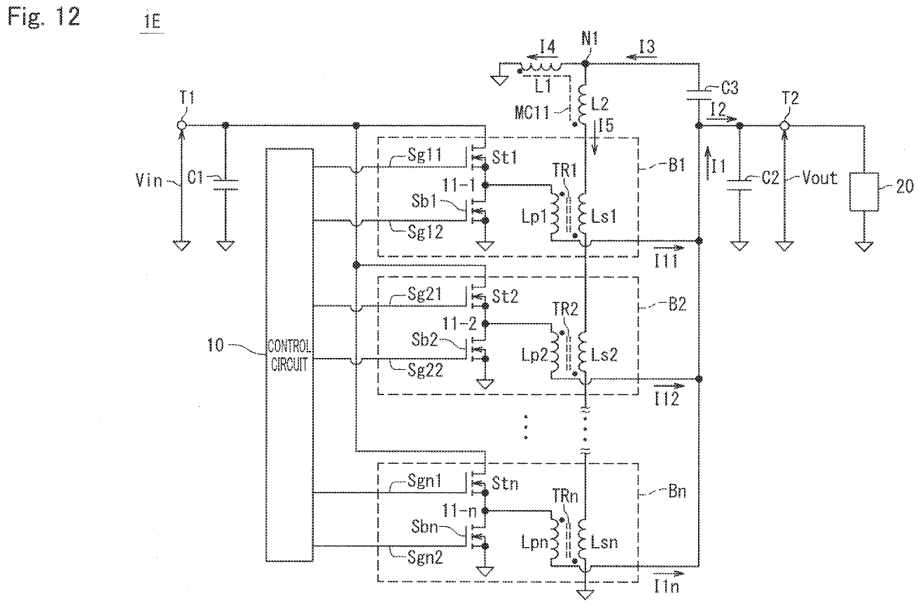

FIG. 12 is a circuit diagram illustrating a configuration example of a DC-DC converter apparatus 1E including a voltage regulator according to a second embodiment. Referring to FIG. 12, a DC-DC converter apparatus 1E according to the second embodiment is different from the DC-DC converter apparatus 1 according to the first embodiment in FIG. 1 in the following points.
(1) A magnetic coupling MC11 is provided between an inductor L1 and an inductor L2.

It is noted that the magnetic coupling of the second embodiment may be applied to other modified embodiments and other embodiments.

The basic operation of the DC-DC converter apparatus 1E configured as described above is similar to that of the first embodiment illustrated in FIG. 6, and the operation and effect are also similar to that of the first embodiment illustrated in FIG. 6. However, setting conditions of a capacitor C3 are different depending on magnetic coupling MC11 of the inductor L1 and the inductor L2.

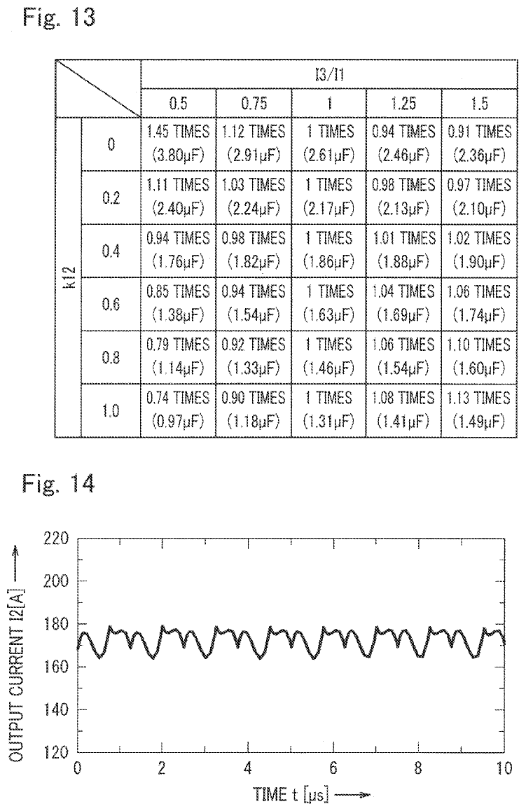

FIG. 13 is a diagram illustrating a setting example table of the capacitor C3 of the DC-DC converter apparatus 1E of FIG. 12. Hereinafter, a setting condition of the capacitor C3 for suppressing noise of an output current I2 will be described with reference to FIG. 13.

A switching frequency of switching circuits 11-1 to 11-n of the respective phases is fs (switching angular frequency ωs=2πfs), and the number of interleaved phases is plurality n. As described above, when the operation phases of the switching circuits 11-1 to 11-n of the respective phases are shifted by 2π/n for operation, the primary to n−1 order current components are canceled out by the effect of interleaving and do not appear in the output current I2. Therefore, it is important to suppress a plurality of nth-order current components. In the following equation expansion, components other than a plurality of nth-order frequency components are ignored. In addition, inductances of inductors Lp1 to Lpn are Lp, and inductances of inductors Ls1 to Lsn are Ls. The inductors Lp1 to Lpn and the inductors Ls1 to Lsn are tightly coupled, and the coupling coefficient can be approximated to 1. On the other hand, a coupling coefficient between the inductors L1 and L2 is set to k12.

nth-order ripple components ip included in currents I11 to I1n flowing through the inductors Lp1 to Lpn of the switching circuits 11-1 to 11-n of the respective phases are defined by the following equation (1) (repeated):

$${i}_{p} = A sin ( n {ω}_{s} t ) . \qquad ( 1 )$$

Referring to FIG. 12, in the total current I1, the nth-order ripple components included in the currents flowing through the inductors Lp1 to Lpn of the switching circuits 11-1 to 11-n of the respective phases are in the same phase and intensify each other. Therefore, the nth-order ripple components included in the total current I1 is expressed by the following equation (2) (repeated):

$${i}_{1} = nA sin ( n {ω}_{s} t ) . \qquad ( 2 )$$

In this case, when all the nth-order ripple components included in the total current I1 flow into the capacitor C3 (I1=I3), a voltage v3 between the terminals of the capacitor C3 is expressed by the following equation (3) (repeated):

$${v}_{3} = - \frac{A}{{ω}_{s} {C}_{3}} cos ( n {ω}_{s} t ) . \qquad ( 3 )$$

At this time, since a voltage potential of a node N1 vibrates in the opposite phase to the voltage v3 between the terminals of the capacitor C3, a current I4 flowing through an inductor L1 and a current I5 flowing through an inductor L2 are expressed by the following equations (8) and (9), respectively:

$${i}_{4} = A \frac{- {L}_{2} - {nL}_{s} + {n}^{2} {ω}_{s}^{2} {k}_{12} {C}_{3} \sqrt{{L}_{p} {L}_{s} {L}_{1} {L}_{2}} + {k}_{12} \sqrt{{L}_{1} {L}_{2}}}{n {ω}_{s}^{2} {L}_{1} {C}_{3} ( {k}_{12}^{2} {L}_{2} - {L}_{2} - {nL}_{s} )} sin ( n {ω}_{s} t ) , \qquad ( 8 )$$

$$and$$

$${i}_{5} = A \frac{{k}_{12} \sqrt{{L}_{1} {L}_{2}} - {n}^{2} {ω}_{s}^{2} {L}_{1} {C}_{3} \sqrt{{L}_{p} {L}_{s}} - {L}_{1}}{n {ω}_{s}^{2} {L}_{1} {C}_{3} ( {k}_{12}^{2} {L}_{2} - {L}_{2} - {nL}_{s} )} sin ( n {ω}_{s} t ) . \qquad ( 9 )$$

In this case, since I3=I4+I5 is obtained from Kirchhoff's current law, a conditional formula for the capacitor C3 satisfying this condition is expressed by the following equation (10):

$${C}_{3} = \frac{2 {k}_{12} \sqrt{{L}_{1} {L}_{2}} - {L}_{1} - {L}_{2} - {nL}_{s}}{{n}^{2} {ω}_{s}^{2} ( {k}_{12}^{2} {L}_{1} {L}_{2} + \sqrt{{L}_{p} {L}_{s}} {L}_{1} - {k}_{12} \sqrt{{L}_{p} {L}_{s} {L}_{1} {L}_{2}} - {L}_{1} {L}_{2} - {nL}_{1} {L}_{s} )} . \qquad ( 10 )$$

When the capacitor C3 satisfies the above equation (10), since the current I1=I3, the output current I2=0 according to Kirchhoff's current law, and the output current I2 does not include any nth-order current component. That is, all the nth-order noise current components can be canceled out.

The above equation (10) is the optimum condition.

Next, an indication (schematic value) of a setting range for obtaining an effective noise reduction effect will be described with reference to FIG. 13. In this case, the inductance Lp=Ls=1 μH, the inductor L1=20 nH, the inductor L2=0.2 μH, the switching frequency fs=200 kHz, and the number of phases n=4. The vertical axis in FIG. 13 is a coupling coefficient k12 of the inductors L1 and L2. In addition, the horizontal axis in FIG. 13 represents a ratio value of the current I3 to the total current I1 illustrated in FIG. 12.

As is clear from FIG. 13, when I3/I1=0.5, since I2=I1−I3=0.5×I1 is satisfied according to Kirchhoff's current law, the ripples included in the output current I2 are reduced by half. When I3/I1=1, since the output current I2=I1−I3=0 according to Kirchhoff's current law, the ripple included in the output current I2 is 0. When I3/I1=1.5, since I2=I1−I3=−0.5×I1 according to Kirchhoff's current law, the ripple included in the output current I2 is reduced by half. That is, the parentheses in FIG. 13 indicate the value of the capacitor C3 for obtaining the noise reduction effect of half or more. Then, the magnification of the capacitance value with respect to the capacitance value of the capacitor C3 under the optimum condition (I3/I1=1) is described.

For example, when the coupling coefficient k12=0.4, the range of the capacitor C3 in which the effect of the noise half or more is obtained is 1.76 μF to 1.90 μF, which is a value 0.94 times to 1.02 times the optimum value 1.86 μF. In FIG. 13, the minimum magnification is 0.74 and the maximum magnification is 1.45. That is, when the capacitance value of the capacitor C3 is set between 0.75 times and 1.5 times the capacitance value calculated by the equation (10) as a guideline of the setting range, the noise reduction effect can be obtained. Also in this case, by reducing the number of components of a noise filter 12, downsizing and cost reduction can be realized.

As illustrated in FIG. 12, the magnetic coupling between the inductors Lp1 to Lpn and the inductors Ls1 to Lsn is performed in a direction in which the magnetic fluxes intensify each other when the current flows from the terminals of the winding start points denoted by black circles. As a result, the above-described noise suppression effect can be obtained.

The present inventors have performed circuit simulation on the four-phase interleaving (n=4) type DC-DC converter apparatus 1E.

FIG. 14 is a waveform diagram of the output current I2 illustrating a simulation result of the DC-DC converter apparatus 1E of FIG. 12. Referring to FIG. 14, the effect of reducing ripple current is shown by circuit simulation in the case of four-phase interleaving (n=4) as an example. FIG. 14 shows simulation results of the output current I2 when the input voltage Vin=12 V and the output voltage Vout=1.8 V.

In the DC-DC converter apparatus 1E according to the second embodiment of FIG. 12, the inductance Lp=Ls=1 μH, the inductor L1=20 nH, the inductor L2=0.2 μH, and the switching frequency fs=200 kHz. In addition, the coupling coefficient k12=0.1. At this time, the optimum capacitance value of the capacitor C3 is calculated to be 2.37 μF by the equation (6).

As is clear from FIG. 14, the ripple component of 4 times the switching frequency included in the total current I1 is removed, and the amplitude of the output current I2 is remarkably suppressed to 14 Ap-p (in the second conventional example, 75 Ap-p).

The response speed to a sudden change in the load is determined by the total inductance of the loop circuit of the inductor. In the above simulation, the value of the inductor Ls is the same between the second conventional example and the second embodiment (Ls1=Ls2= . . . =Lsn). Therefore, when compared with other inductances, L1=0.2 μH in the second conventional example, and

$$L 1 + L 2 - 2 \times k 12 \times \sqrt{L 1 \times 12} = 0.214 μ H$$

in the first embodiment, and thus, almost the same response speed is obtained.

In this case, the four-phase interleaved DC-DC converter apparatus 1E has been described, but the number of phases is not limited, and the present disclosure may be applied to any n-phase interleaved DC-DC converter apparatus. As a result, in an interleaved DC-DC converter apparatus having an arbitrary number of phases, noise of the output current can be suppressed.

In addition, any one pair of or a combination of three inductors among the inductors Lp1 to Lpn may be magnetically coupled to each other. For example, in the case of a four-phase interleaved DC-DC converter apparatus, the inductor Lp1 and the inductor Lp2 may be coupled, and the inductor Lp3 and the inductor Lp4 may be coupled. As a result, the response speed to the load fluctuation can be further increased as compared with the case where the coupling is not performed.

For the switch elements St1 to Stn and Sb1 to Sbn, for example, a transistor such as a MOSFET or a GaN-HEMT may be used. In addition, diodes may be used for the switch elements Sb1 to Sbn.

In addition, in FIG. 12, since the inductor L2 and the inductors Ls1 to Lsn are connected in series, the order of connection may be switched. As a result, the component arrangement on the circuit board can be optimized, and the mounting area can be further suppressed. As illustrated in FIG. 12, in a case where the inductor L1 and the inductor L2 are both connected to the node N1, a coupled inductor including the inductor L1 and the inductor L2 can be formed as a three-terminal component, which facilitates mounting.

As described above, according to the present embodiment, for example, in a voltage regulator such as TLVR, it is possible to provide a voltage regulator capable of suppressing ripples of an output current while maintaining the response to a load fluctuation without using a large noise filter, and a power converter apparatus including the voltage regulator.

### Third Embodiment

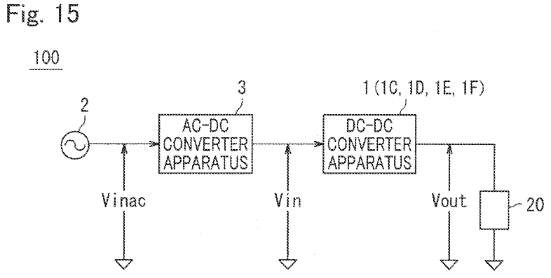

FIG. 15 is a block diagram illustrating a configuration example of a power converter apparatus 100 according to a third embodiment. Referring to FIG. 15, the power converter apparatus 100 includes an AC-DC converter apparatus 3 that is provided in a preceding stage of the DC-DC converter apparatus 1 (or 1C, 1D, 1E, 1F) of the first or second embodiment or the first or second modified embodiment.

Referring to FIG. 15, an AC voltage Vinac from an AC power supply 2 is input to an AC-DC converter apparatus 3, and the AC-DC converter apparatus 3 includes a predetermined rectifying and smoothing circuit, rectifies and then smooths the input Vinac, and outputs the output voltage to the DC-DC converter apparatus 1 (or 1C, 1D, 1E, 1F) as the input voltage Vin. Next, the DC-DC converter apparatus 1 smooths and switches the input voltage Vin, which is an input DC voltage, and then smooths the input voltage Vin to generate, for example, a stepped-down or stepped-up DC output voltage Vout, and outputs the stepped-down or stepped-up DC output voltage Vout to a load 20.

According to the power converter apparatus 100 configured as described above, since the DC-DC converter apparatus 1 (or 1C, 1D, 1E) is provided, it is possible to suppress ripples of the output current while maintaining the response to load fluctuation without using a large noise filter.

### Modified Embodiments

In the above embodiments and first to third modified embodiments, the step-down chopper circuits B1 to Bn are used, but the present disclosure is not limited thereto, and a step-up chopper circuit may be used.

In the above embodiments and first to third modified embodiments, for example, the chopper circuits B1 to Bn of the four-phase interleaved system have been described, but the present disclosure is not limited thereto, and for example, a chopper circuit of a multi-phase interleaved system such as 16 phases may be used.

### INDUSTRIAL APPLICABILITY

The voltage regulator or the power converter apparatus including the voltage regulator according to the present disclosure is useful for realizing a power conversion circuit apparatus used in an in-vehicle device, an industrial device, or the like with low ripple, low noise, small size, and low cost.

1. A voltage regulator comprising:
a plurality of chopper circuits connected in parallel between an input terminal and an output terminal, each of the plurality of chopper circuits being configured to switch an input voltage input to the input terminal and then output the input voltage from the output terminal via a first inductor of a primary winding of a transformer, the transformer including the primary winding and a secondary winding that are magnetically coupled with each other; and
a second series circuit including a first series circuit and a third inductor that are connected in series, the first series circuit being configured by connecting respective second inductors of the secondary windings of the respective transformers of the plurality of chopper circuits in series, both ends of the second series circuit being connected to first and second connection points connected to each other,
wherein the voltage regulator comprises:
a first capacitor connected to be inserted between the first connection point and the output terminal; and
a fourth inductor, which is configured to be one of the following:
(1) the fourth inductor is connected to be inserted between the first connection point and one end of one of the second inductors that is connected closest to the first connection point,
(2) the fourth inductor is connected to be inserted between the second connection point and one end of one of the second inductors that is connected closest to the second connection point, or
(3) the fourth inductor is connected to be inserted between any pair of adjacent inductors of the plurality of second inductors.

2. The voltage regulator as claimed in claim 1, further comprising:
a second capacitor that is connected to the input terminal and smooths the input voltage; and
a third capacitor that is connected to the output terminal and smooths an output voltage output from the output terminal,
wherein the input voltage and the output voltage are both DC voltages, and the voltage regulator is a DC-DC converter apparatus.

3. The voltage regulator as claimed in claim 1,
wherein the plurality of n chopper circuits operates in a plurality of n phases different from each other, and
wherein a switching angular frequency of the plurality of chopper circuits is ωₛ,
an inductance of the first inductors is Lₚ,
an inductance of the second inductors is Lₛ,
an inductance of the third inductor is L₁, and
an inductance of the fourth inductor is L₂,
then, a capacitance value C₃ of the first capacitor is configured to satisfy the following equation:
$${C}_{3} = \frac{{L}_{2} + {nL}_{s} + {L}_{1}}{{n}^{2} {ω}_{s}^{2} {L}_{1} ( {L}_{2} + {nL}_{s} - \sqrt{{L}_{p} {L}_{s}} )} . \qquad ( 1 )$$

4. The voltage regulator as claimed in claim 1,
wherein the plurality of n chopper circuits operates in a plurality of n phases different from each other, and
wherein a switching angular frequency of the plurality of chopper circuits is ωₛ,
an inductance of the first inductors is Lₚ,
an inductance of the second inductors is Lₛ,
an inductance of the third inductor is L₁, and
an inductance of the fourth inductor is L₂,
then, a capacitance value C₃ of the first capacitor is configured to satisfy the following equation:
$$\frac{{L}_{2} + {nL}_{s} + {L}_{1}}{{n}^{2} {ω}_{s}^{2} {L}_{1} \{ 1.5 ( {L}_{2} + {nL}_{s} ) - \sqrt{{L}_{p} {L}_{s}} \}} < {C}_{3} < \frac{{L}_{2} + {nL}_{s} + {L}_{1}}{{n}^{2} {ω}_{s}^{2} {L}_{1} \{ 0.5 ( {L}_{2} + {nL}_{s} ) - \sqrt{{L}_{p} {L}_{s}} \}} . \qquad ( 2 )$$

5. The voltage regulator as claimed in claim 1,
wherein the third inductor and the fourth inductor are magnetically coupled to each other.

6. The voltage regulator as claimed in claim 5,
wherein the plurality of n chopper circuits operates in a plurality of n phases different from each other, and
wherein a switching angular frequency of the plurality of chopper circuits is ωₛ,
an inductance of the first inductors is Lₚ,
an inductance of the second inductors is Lₛ,
an inductance of the third inductor is L₁,
an inductance of the fourth inductor is L₂, and
a coupling coefficient between the third inductor and the fourth inductor is k₁₂,
then, a capacitance value C₃ of the first capacitor is configured to satisfy the following equation:
$${C}_{3} = \frac{2 {k}_{12} \sqrt{{L}_{1} {L}_{2}} - {L}_{1} - {L}_{2} - {nL}_{s}}{{n}^{2} {ω}_{s}^{2} ( {k}_{12}^{2} {L}_{1} {L}_{2} + \sqrt{{L}_{p} {L}_{s}} {L}_{1} - {k}_{12} \sqrt{{L}_{p} {L}_{s} {L}_{1} {L}_{2}} - {L}_{1} {L}_{2} - {nL}_{1} {L}_{s} )} . \qquad ( 3 )$$

7. The voltage regulator as claimed in claim 6,
wherein the capacitance value C₃ of the first capacitor is a value within a range of 0.75 times to 1.5 times a capacitance value calculated by the equation (3) as claimed in claim 6.

8. The voltage regulator as claimed in claim 1,
wherein among the plurality of first inductors, a pair of, a plurality of pairs of, or a combination of three or more first inductors are magnetically coupled to each other.

9. The voltage regulator as claimed in claim 1, further comprising a fifth inductor connected in series with the first capacitor between the first connection point and the output terminal.

10. The voltage regulator as claimed in claim 1, further comprising a switch connected in series with the first capacitor between the first connection point and the output terminal.

11. A power converter apparatus as claimed in claim 2, comprising:
a DC-DC converter apparatus that is the voltage regulator; and
an AC-DC converter apparatus that is provided at a preceding stage of the DC-DC converter apparatus, converts an AC voltage into a DC voltage, and outputs the DC voltage to the DC-DC converter apparatus.
